(19) United States
(12) Patent Application Publication
(10) Pub. No.: US 2025/0021344 A1
(43) Pub. Date: Jan. 16, 2025

(54) USER INTERFACE FOR TRANSITIONING A CLUSTER TO DESIRED STATE CONFIGURATION MANAGEMENT

(71) Applicant: VMware LLC, Palo Alto, CA (US)

(72) Inventors: Branislav ABADZHIMARINOV, Sofia (BG); Georgi HRISTOZOV, Sofia (BG); Mihail IVANOV, Sofia (BG); Atanas VASILEV, Sofia (BG); Petia RADEVA, Sofia (BG); Harshath JOOTOO RAMESH BAPU, Newark, CA (US); Mayur BHOSLE, Sunnyvale, CA (US)

(21) Appl. No.: 18/352,641

(22) Filed: Jul. 14, 2023

(51) Int. Cl. G06F 9/445

(52) U.S. Cl. CPC G06F 9/44505

(57) ABSTRACT

Disclosed herein are a system and method for transitioning a cluster of host computer systems from being configured imperatively to being configured declaratively according to a configuration profile. First, the eligibility of the cluster to be transitioned is determined. Next, a transition wizard is started, which guides the administrator through the steps of the transition. The steps include obtaining the configuration profile, validating the configuration, viewing compliance to the configuration by the cluster, performing a pre-check, and then applying the configuration to the cluster when the validation and pre-check are successful. In this manner, all of the hosts in the cluster are properly configured according to the declarative profile, and error-prone manual configuration is eliminated.

### BACKGROUND

Software-defined networking (SDN) comprises a plurality of hosts in communication over a physical network infrastructure, each host having one or more virtualized endpoints such as VMs, containers, or other virtual computing instances (VCIs) that are connected to logical overlay networks that may span multiple hosts and are decoupled from the underlying physical network infrastructure. Though certain aspects are discussed herein with respect to VMs, it should be noted that they may similarly be applicable to other suitable VCIs. Furthermore, certain aspects discussed herein may similarly be applicable to physical machines. Some embodiments of the present disclosure may also be applicable to environments including both physical and virtual machines.

SDN generally involves the use of a control plane (CP) and a management plane (MP). The control plane is concerned with determining the logical overlay network topology and maintaining information about network entities such as logical switches, logical routers, endpoints, etc. The management plane is concerned with receiving network configuration input from an administrator or orchestration automation and generating desired state data that specifies how the logical network should be implemented in the physical infrastructure. The management plane may have access to a database application for storing the network configuration input. In some cases, the management plane is implemented via one or more management servers.

A management server generally allows combining multiple hosts in a cluster. Traditionally, the host configuration is done through imperative APIs (Application Programming Interfaces) on a per-host basis. Imperative programming generally involves an explicit sequence of commands describing how a computer performs one or more tasks. In some cases, imperatively configuring a host can be rigid, can require an administrator to have extensive programming knowledge, and can be time-consuming to implement.

### SUMMARY

One embodiment provides a method for managing a cluster of host computer systems to operate according to a declarative configuration. The method includes navigating to a configuration screen. The method further includes, while in the configuration screen, performing actions that include: obtaining the declarative configuration; validating the declarative configuration; displaying an indication of compliance by the cluster of host computer systems with the declarative configuration, where the cluster of host computer systems was previously configured imperatively. The method further includes performing a pre-check on the host computer systems in the cluster of host computer systems and applying the declarative configuration to the cluster of host computer systems based on the validating being successful and the pre-check being successful.

Further embodiments include a computer-readable medium containing instructions for carrying out one more aspects of the above method and a computer system configured to carry out one or more aspects of the above method.

### BRIEF DESCRIPTION OF DRAWINGS

FIG. 1 depicts a representative host computer system.

FIG. 2 depicts a cluster with a management system.

FIG. 3 depicts a management system with groups of servers and storage.

FIG. 4 depicts a top-level flow chart for transitioning to a declarative configuration, in an embodiment.

FIGS. 5, 6, and 7 depict a flow of operations for eligibility, in an embodiment.

FIG. 8 depicts a flow of operation for displaying views, in an embodiment.

FIG. 9 depicts a flow of the host view function, in an embodiment.

FIG. 10 depicts a flow of operations for screens in the configuration view, in an embodiment.

FIG. 11 depicts a flow of operations for allowed operations in the configuration view, in an embodiment.

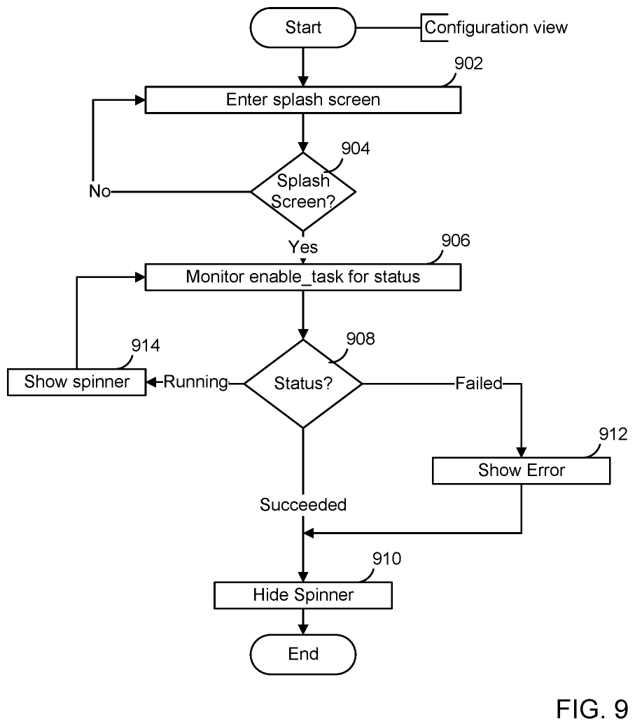

FIG. 12 depicts a flow of operations for a configuration manager transition wizard, in an embodiment.

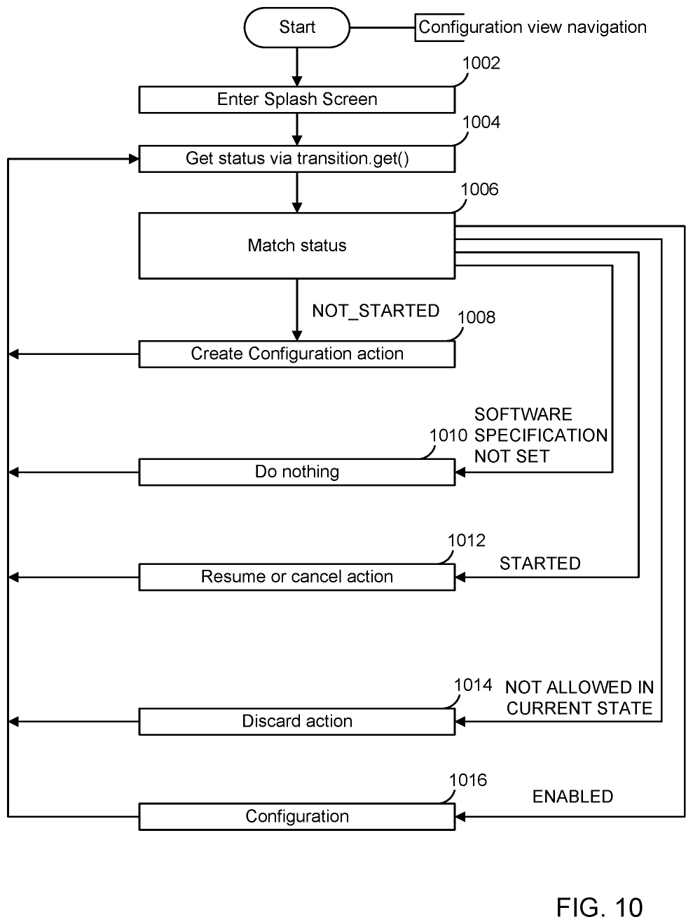

### DETAILED DESCRIPTION

Embodiments of the present disclosure allow a cluster of hosts to be transitioned from being imperatively configured to a declarative configuration scheme in an efficient, scalable manner. While imperative programming generally involves an explicit sequence of commands that describe how a computer is to perform one or more tasks, declarative programming involves specifying a desired result (e.g., desired state) without directly specifying the explicit sequence of commands that describe how the computer is to achieve the desired result.

According to certain embodiments, configuration profiles, defined at the cluster level, allow the description of a desired state of a host configuration. Managing the configuration at the cluster level using configuration profiles ensures that all of the hosts in the cluster have a consistent configuration and eliminates the need to configure the hosts manually.

As described herein, an administrator may transition an existing cluster of host computer systems from being configured imperatively to being configured declaratively using a desired state-based configuration (a configuration profile). Transitioning the cluster involves multiple steps including: (1) checking eligibility for the transition, (2) defining the configuration profile, (3) validating the host configuration, (4) evaluating the impact on the hosts, and (5) applying the configuration to the cluster. This requires complex interaction patterns in the user interface.

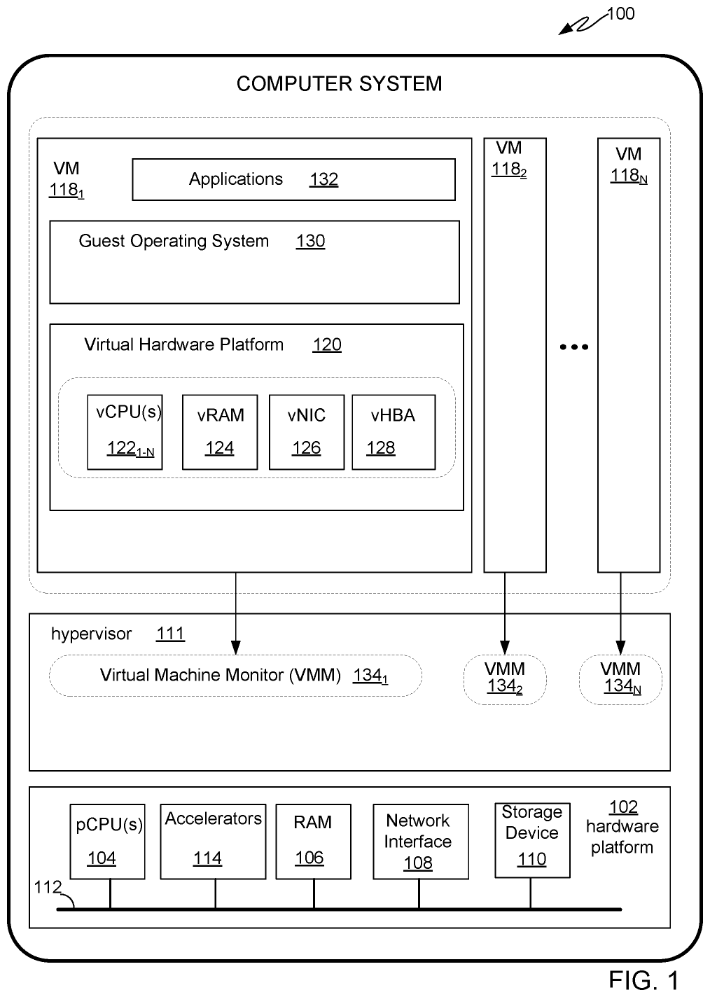

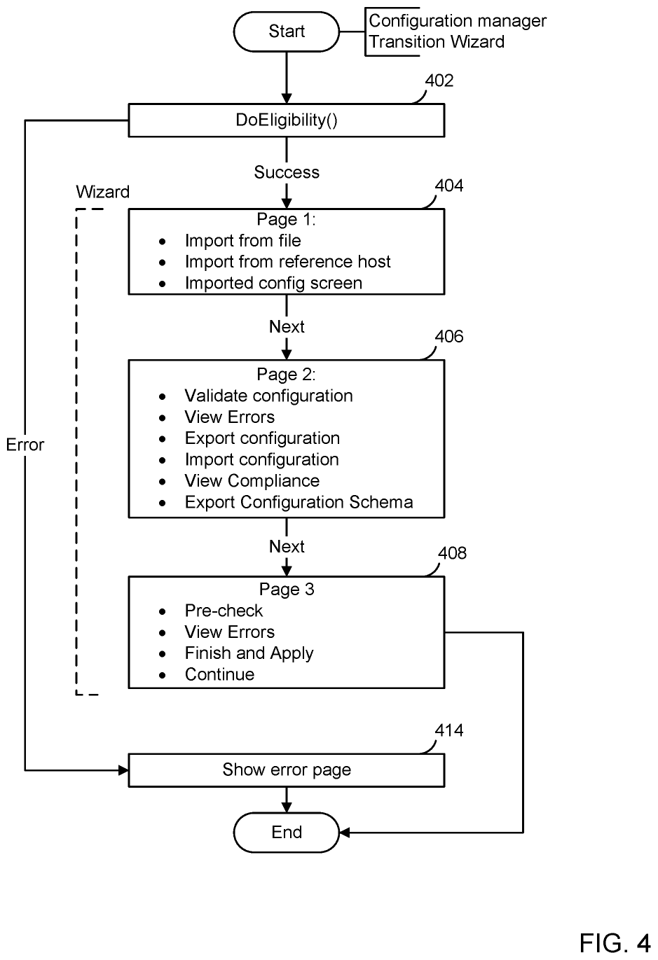

FIGS. 1-3 depict aspects of an SDDC environment in which embodiments of the present disclosure may be implemented, while FIGS. 4-10 depict detailed workflows for enabling an efficient transition of an existing cluster of host computer systems from being configured imperatively to being configured declaratively according to a prescribed configuration.

FIG. 1 depicts a block diagram of a host computer system that is representative of a virtualized computer architecture. As is illustrated, host computer system 100 supports multiple virtual machines (VMs) 118₁-118_{N}, which are an example of virtual computing instances (VCIs) that run on and share a common hardware platform 102. Hardware platform 102 includes conventional computer hardware components, such as random access memory 106 (RAM), one or more network interfaces 108, persistent storage device 110, and one or more physical central processing units (pCPUs) 104. pCPUs 104 may include central processing units having multiple cores.

A virtualization software layer, hereinafter referred to as a hypervisor 111, is installed on top of hardware platform 102. Hypervisor 111 makes possible the concurrent instantiation and execution of one or more VMs 118₁-118_{N}. The interaction of a VM 118 with hypervisor 111 is facilitated by the virtual machine monitors (VMMs) 134₁-234_{N}. Each VMM 134₁-134_{N} is assigned to and monitors a corresponding VM 118₁-118_{N}. In one embodiment, hypervisor 111 may be a VMkernel™ which is implemented as a commercial product in VMware's vSphere® virtualization product, available from VMware™ Inc. of Palo Alto, CA. In an alternative embodiment, hypervisor 111 runs on top of a host operating system, which itself runs on hardware platform 102. In such an embodiment, hypervisor 111 operates above an abstraction level provided by the host operating system.

After instantiation, each VM 118₁-118_{N} encapsulates a virtual hardware platform 120 that is executed under the control of hypervisor 111. Virtual hardware platform 120 of VM 118₁, for example, includes but is not limited to such virtual devices as one or more virtual CPUs (vCPUs) 122₁-122_{N}, a virtual random access memory (vRAM) 124, a virtual network interface adapter (vNIC) 126, and virtual storage (vStorage) 128. Virtual hardware platform 120 supports the installation of a guest operating system (guest OS) 130, which is capable of executing applications 132. Examples of guest OS 130 include any of the well-known operating systems, such as the Microsoft Windows™ operating system, the Linux™ operating system, and the like.

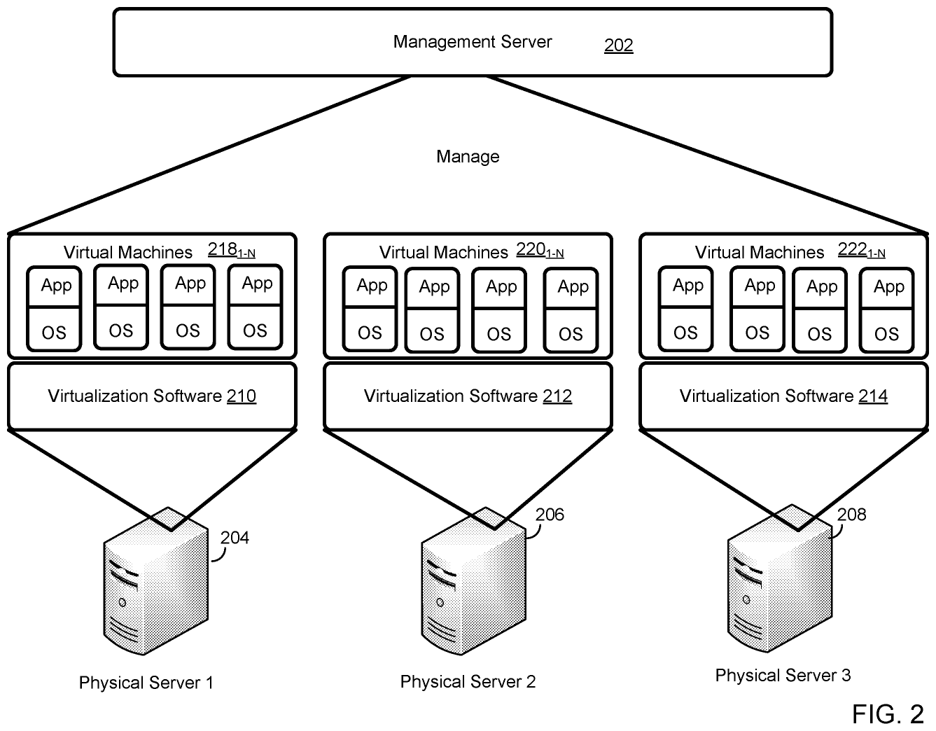

FIG. 2 depicts a cluster with a management system. The cluster includes a plurality of physical servers 204, 206, 208, each having virtualization software 210, 212, 214, and each supporting a number of virtual machines 218_{1-N}, 220_{1-N}, 222_{1-N}, respectively. The cluster of physical servers 204, 206, 208 is managed by a management server 202.

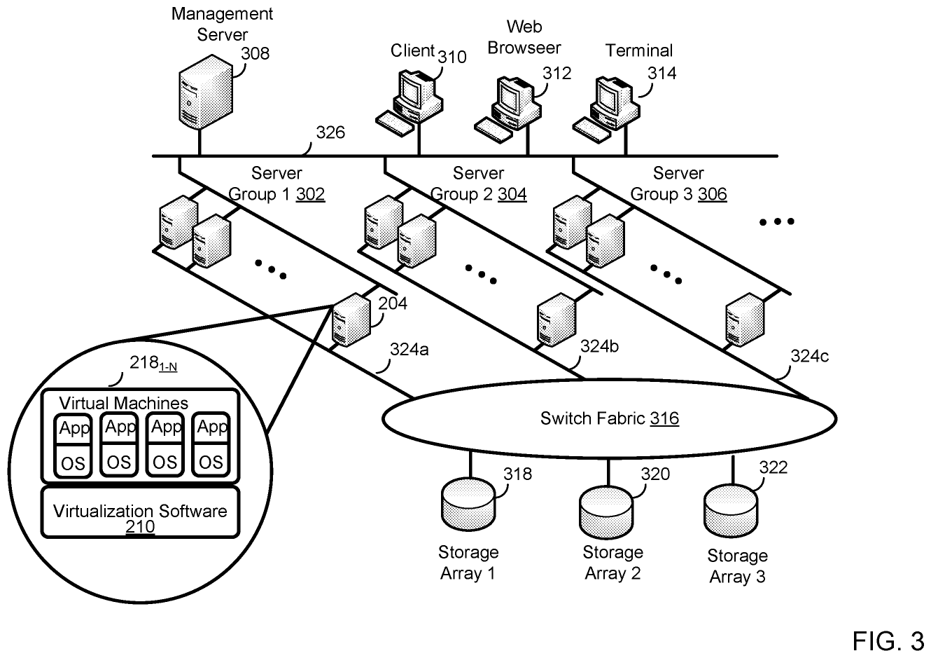

FIG. 3 depicts a management system with groups of servers and storage. Each of the physical servers in a server group 302, 304, 306 runs a plurality of virtual machines, as depicted in FIG. 2, and is connected via a first network 326 to a management server 308, a client 310, a web browser 312, and a terminal 314 and connected via a second network 324a, 324b, 324c to a switch fabric 316 by which the physical servers access one or more storage arrays 318, 320, 322.

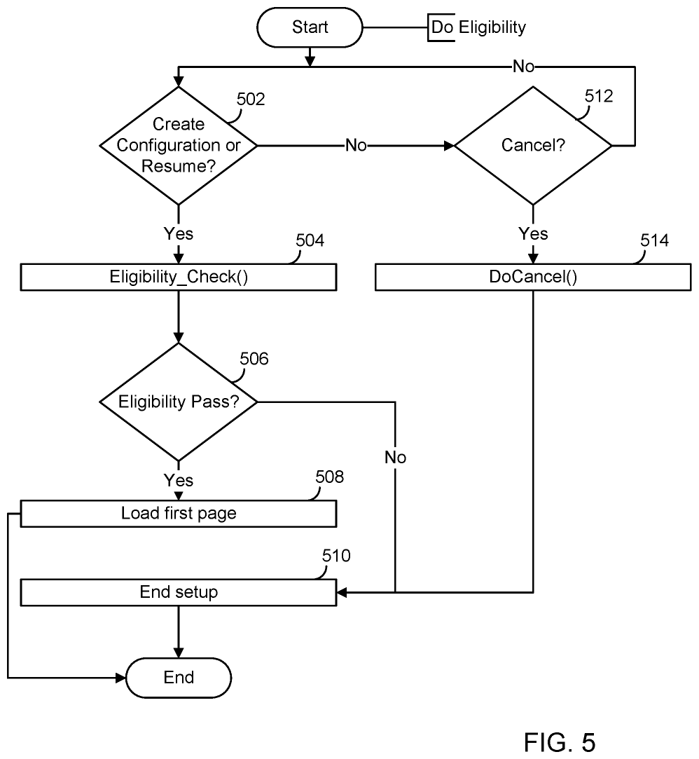

FIG. 4 depicts a top-level flow chart for transitioning to a declarative configuration, in an embodiment. A user interface, via client 310 in FIG. 3, allows an administrator to transition an existing cluster of hosts from an imperatively-defined configuration to a desired state-based configuration (declaratively defined). The administrator uses an inline workflow user interface (also referred to as a transition wizard) as a step-by-step guide to complete the transition. In addition, progress at certain points along the workflow is saved so that the workflow can be resumed after a pause or interruption in the flow. The transition wizard has three main pages in which various actions are allowed, leading the administrator in an orderly manner to a declarative-defined configuration. Before running the transition wizard, the administrator performs an eligibility check. Thus, in step 402, the flow calls a DoEligibility function, which is described in reference to FIGS. 5 and 6. If the eligibility check succeeds, then the administrator navigates to page 1 of the configuration wizard (step 404). If the eligibility check fails, flow proceeds to step 414, which shows the errors related to the check.

### Page 1

In step 404, when createConfiguration was called, page 1 shows a selection for importing the configuration document from either a local file or from a reference host.

If ‘import from file’ is selected, the configuration is selected from a file in the local file system using the importConfig function. A graphical component such as a spinner (e.g., an animated spinning circular component that indicates a pending task) may be depicted until the response is received. If an error occurs, the error is shown in a red alert on top of the dialog. A browse button and the file name are available for action or review.

If ‘import from the reference host’ is selected, the dialog shows the host from the selected cluster. A search box is used to filter the listed items based on their cell values. On the dialog are selections for close or import. The import selection is enabled only if there is a selection.

If the flow is resumed (i.e., the wizard was started but was not finished), the screen shows the hostname or the file name from which the configuration was imported.

Upon completing the import, a current empty page is replaced by a new page that shows the imported file name or the name of the host from which the configuration was imported. Both import actions remain on the page to allow a new import.

Once these actions are completed, the administrator proceeds via a ‘next’ selection to page 2.

### Page 2

In step 406, upon entering page 2, the validateConfig_task function is called. The configuration validation process generally involves verifying that the configuration is internally consistent, free of errors, complete (e.g., including all necessary information), and/or the like. Until the configuration validation check completes, the page may show a graphical component, such as a spinner. A green banner may be shown in the case of a successful validation. A red banner may be shown in the case of a failed validation. The validation results are depicted in the ValidateResult.status field. In the case of an invalid configuration, the errors are available in ValidateResult.errors.

If the validation succeeds, an auto-compliance check is performed. The results of the check are available in the ValidateResult.compliance field. A yellow banner may be shown with the view compliance action available in page 2.

In the case of a failed configuration validation, the error details are shown upon selecting ‘View errors’ inside the (e.g., red) banner.

Export configuration allows the administrator to get the current configuration, alter it, and then import it back.

Import performs the same function as import from a file on page 1.

Viewing compliance allows the configuration compliance to be shown.

Export configuration schema allows the administrator to download configuration spec metadata (i.e., the schema) for easier configuration specification editing.

Selecting ‘Next’ advances the wizard to page 3.

### Page 3

Upon entering page 3 in step 408, the flow calls the transition precheck_task function. In the precheck_task function, the system runs health checks on each host and the entire cluster. The precheck_task function also determines the impact, such as entering maintenance mode or rebooting, on the hosts in complying with the desired configuration. The page may show a graphical component, such as a spinner, while the pre-check task is running. The ‘Continue’ and ‘Finish and Apply’ selections are enabled. The pre-check task returns a ClusterPrecheckResult, which contains information about the cluster (represented as the root of a tree), its hosts (as child nodes of the root), and precheck issues for each host (as child of each host and leaves of the tree).

If pre-check succeeds, a green banner may be displayed along with a summary and host impact information.

If pre-check fails, a red banner may be displayed with a link to ‘view errors.’

Upon selecting ‘Finish and Apply,’ a confirmation message is displayed.

Selecting the ‘Continue’ action enables the Configuration manager (CMan).

Selecting ‘enable’ converts the legacy cluster to a CMan-enabled one.

The implemented user interface allows performing all those operations described above in an interactive workflow. The state of the progress of the administrator is saved at specific milestones and can be restored.

If the cluster does not support the CMan, a ‘Configuration Not Supported’ view is displayed instead of the Transition splash screen.

### Eligibility

As mentioned above, eligibility checks are performed before starting the transition wizard (i.e., before the initial opening of page 1 of the wizard, regardless of the wizard's state. Eligibility checks expose information, warnings, and error messages relating to cluster eligibility. For example, stateless or old-version hosts are not eligible for transition. If a host profile is attached to the hosts, a warning is displayed that the profile should be detached. Also, if the cluster is not managed with a single image, the cluster is not eligible for enabling Configuration profiles.

FIGS. 5, 6, and 7 depict a flow of operations for eligibility, in an embodiment. FIG. 5 depicts a top level flow. FIG. 6 depicts the DoEligibility function. FIG. 7 depicts the EligibilityCheck function.

Referring to FIG. 5, if ‘Create configuration or Resume’ is ‘True’ as determined in step 502, then the EligibilityCheck_task is called. If ‘Create configuration or Resume’ is not True and ‘Cancel’ is True as determined in step 512, then the ‘DoCancel’ function is called in step 514.

In step 504 of the DoEligibility function of FIG. 5, the function performs the EligibilityCheck_task, which is further described in reference to FIG. 6. If ‘EligibilityPass’ is true, as determined in step 506, the function loads the first page in step 508. If ‘EligibiltyPass’ is false, the function ends the setup in step 510.

FIG. 6 depicts a flow of operations for the EligibilityCheck_task, in an embodiment. In step 602 of FIG. 6, the EligibilityCheck_task tests the eligibility task result. If the result is ready and the task succeeded as determined in step 604, and the result status is ‘OK’ as determined in step 606, then the function shows the task result notifications in step 608 and sets ‘EligibilityPassed’ to True in step 610.

If the task did not succeed, as determined in step 604, then in step 616, the function shows the task error message, and in step 618, the function shows the task result notification and sets ‘EligibilityPassed’ to False in step 620.

If the task result is ‘not OK,’ as determined in step 606, then, in step 612, the function shows the task result notification, and in step 614 sets ‘EligibilityPassed’ to False.

In step 622, the function returns the value of ‘EligibilityPassed’, which is used in step 604 of FIG. 6.

### Views

FIG. 7 depicts a flow of operations for displaying different views, in an embodiment. The different views include a ‘host settings not supported view,’ an ‘Enable IMan View,’ ‘a Configuration View,’ a ‘Resume Transition splash view,’ ‘a fast transition splash view,’ and ‘a new transition splash view.’

In step 702, host settings are selected. In step 704, a value indicating whether a declarative configuration is supported is obtained.

In step 706, the value is tested. If declarative management is not supported, the view is set to ‘host settings not supported view’ in step 708.

If declarative management is supported as determined in step 706, then in step 710, status is obtained via a transition.get function. If, according to the status, ‘IMan is enabled on cluster,’ as determined in step 712, then the view is set to ‘Enable IMan view’ in step 714, wherein ‘IMan’ refers to an image manager that displays the various views.

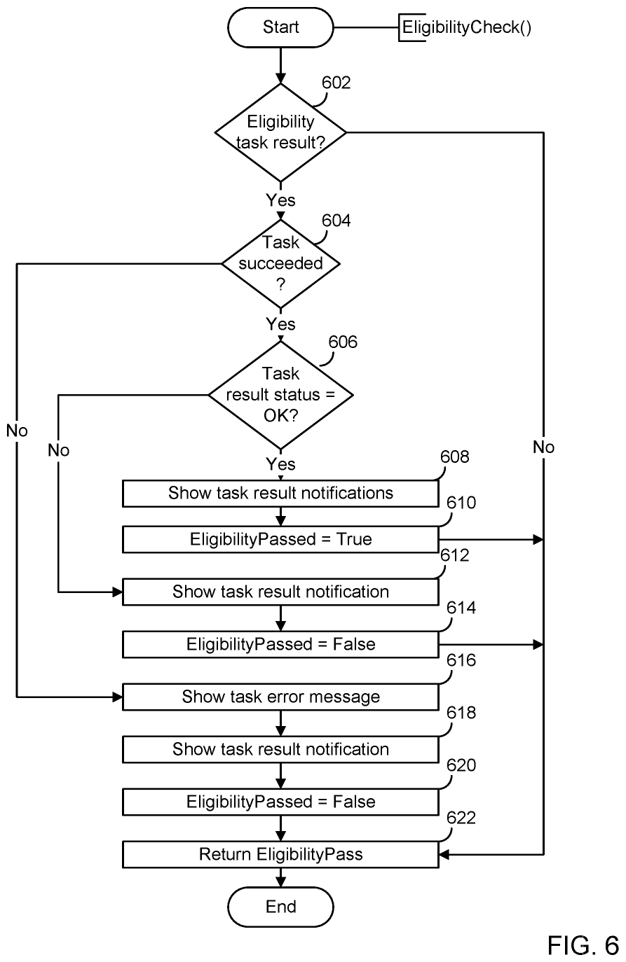

If not, then the host view (HSV) function is called in step 716. The HSV function is described in reference to FIG. 8. If the result of the HSV function is ‘True’ (i.e., ‘Succeeded’) as determined in step 716, then the view is set to ‘Configuration View’ in step 720. In this view, the configuration of the cluster can occur.

If the result of the HSV function is ‘False’ (i.e., ‘Failed’) as determined in step 716, then if ‘Enable CMan Pending to start’ is ‘True’ as determined in step 722, the view is set to ‘Resume Transition Splash’ view in step 724. Thus, the ‘Resume Transition Splash’ view is presented when the transition was started but not finished. The administrator navigated to the cluster's summary view without canceling the transition wizard. In this view, the interface starts with a pre-filled configuration. The administrator can choose to continue with the previous transition by selecting ‘Resume’ or start over by selecting ‘Start Over.’ The administrator can also start over by selecting ‘Cancel’ or ‘Discard.’

In the case of selecting ‘Resume,’ checkEligibility_task is called, which starts the eligibility checks. The function transition.get returns the current transition flow state.

In the case of selecting ‘Start Over,’ reset_task is called, which starts the eligibility checks.

In the case of selecting ‘Cancel,’ a transition.cancel function is called to reset the transition state. The transition.cancel function deletes the current state of the flow regardless of the person starting the transition.

In the case of selecting ‘Discard,’ a transition was started by another user and the current one cannot proceed unless the previously started transition is deleted. The transition.get function returns a status ‘NOT_ALLOWED_IN_CURRENT_STATE,’ prompting the selection of ‘Discard.’

If enable ‘CMan pending to start’ is not true and ‘CMan fast transition is available’ is ‘True,’ as determined in step 726, the view is set to ‘Fast Transition splash view’ in step 728. If the cluster can be quickly enabled (i.e., the cluster has no hosts), then ‘Fast transition splash view’ is presented. Setting up host settings directly invokes enable_task instead of the check_eligibilty task. In response to a transition.get function, info.fastTrack is ‘True,’ and info.status is ‘NOT_STARTED.’

If ‘CMan fast transition’ is not available as determined in step 726, then the view is set to ‘New transition splash view’ in step 730.

The ‘New transition splash view’ is the first view presented when the cluster supports configuration management but has not yet been enabled. The screen shows an empty configuration because the transition flow has not yet been started.

### HSV Function

FIG. 8 depicts a flow of the HSV function, in an embodiment. In step 802, if CMan is enabled for the cluster, then a result value is set to ‘True’ in step 804, and that value is returned for the function in step 816.

Otherwise, if in step 806, ‘Enable CMan is in progress,’ then in step 808, the variable ‘enable_task’ is monitored inside a blue banner. If enable_task indicates that the task succeeded as determined in step 810, then the result value is set to ‘True’ in step 812 and returned in step 816.

Otherwise, the result value is set to ‘False,’ in step 814, and the result is returned in step 816.

The result value is used in steps 720 and 722 of FIG. 7.

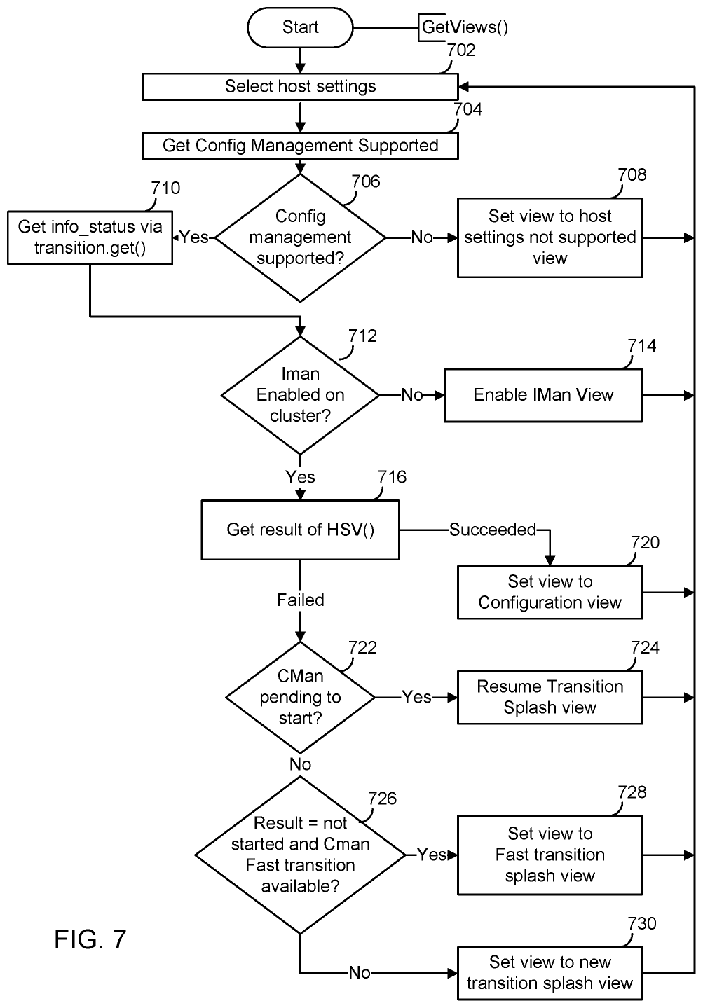

FIG. 9 depicts a flow of operations for screens in the configuration view, in an embodiment. In step 902, the splash screen for the configuration view is entered, and if the screen is present as determined in step 904, monitors ‘enable_task’ for status in step 906. In step 908, the function determines whether the status indicates ‘running,’ ‘succeeded,’ or ‘failed.’

If status indicates ‘running,’ then the function displays a graphical component, such as a spinner in step 914, and returns to 906 to get the status.

If the status indicates ‘succeeded,’ then the function hides the graphical component, such as the spinner in step 910, and ends.

If the status indicates ‘failed,’ then the function shows the error in step 912, hides the graphical component, such as the spinner in step 910, and ends.

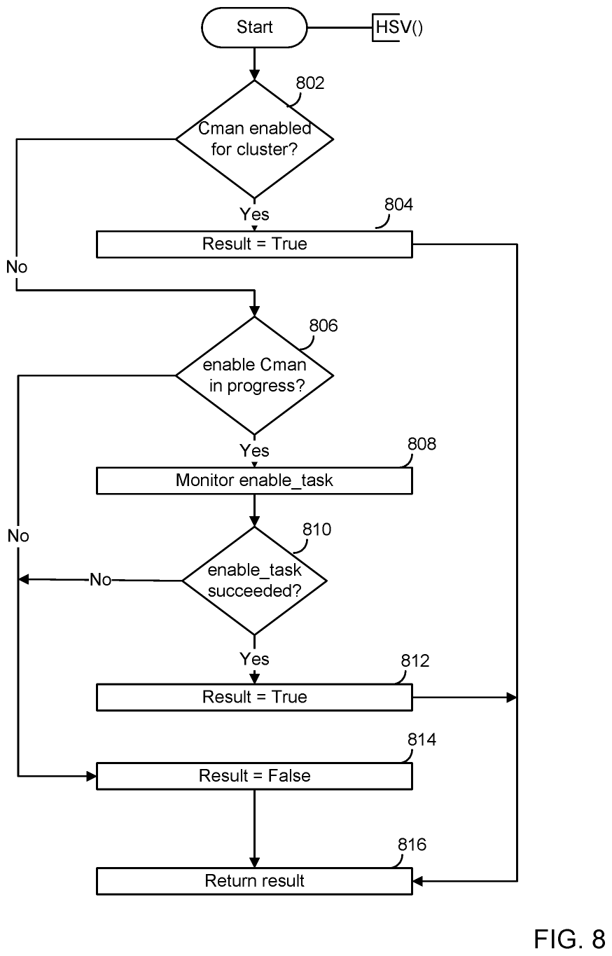

FIG. 10 depicts a flow of operations for allowed operations in the configuration view, in an embodiment. In step 1002, the function enters the splash screen. In step 1004, the function obtains status and matches the status in step 1006 with one of five values.

If the value is ‘NOT_STARTED,’ then the Create Configuration action is available in step 1008.

If the value is ‘SOFTWARE SPECIFICATION NOT SET,’ then action is skipped in step 1010, and flow returns to step 1004.

If the value is ‘STARTED,’ then either ‘Resume’ or ‘Cancel’ actions are allowed in step 1012. Resume indicates that the transition was started but was not finished. Selecting ‘Resume’ causes the flow to continue with a pre-filled configuration and the start of eligibility checks, according to FIG. 5.

If the value is ‘NOT ALLOWED,’ then the ‘Discard’ action is available in step 1014.

If the value is ‘ENABLED,’ then the ‘Configuration’ action is available in step 1016.

Certain embodiments as described above involve a hardware abstraction layer on top of a host computer. The hardware abstraction layer allows multiple contexts to share the hardware resource. These contexts are isolated from each other in one embodiment, each having at least a user application program running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application program runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers, each including an application program and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application program's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained only to use a defined amount of resources such as CPU, memory, and I/O.

Certain embodiments may be implemented in a host computer without a hardware abstraction layer or an OS-less container. For example, certain embodiments may be implemented in a host computer running a Linux® or Windows® operating system.

The various embodiments described herein may be practiced with other computer system configurations, including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data which can thereafter be input to a computer system. Computer-readable media may be based on any existing or subsequently developed technology for embodying computer programs in a manner that enables them to be read by a computer. Examples of a computer-readable medium include a hard drive, network-attached storage (NAS), read-only memory, random-access memory (e.g., a flash memory device), a CD (Compact Discs)—CD-ROM, a CDR, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for managing a cluster of host computer systems to operate according to a declarative configuration, the method comprising:
navigating to a configuration screen; and
while in the configuration screen performing actions that include:
obtaining the declarative configuration;
validating the declarative configuration;
displaying an indication of compliance by the cluster of host computer systems with the declarative configuration, wherein the cluster of host computer systems was previously configured imperatively;
performing a pre-check on the host computer systems in the cluster of host computer systems; and
applying the declarative configuration to the cluster of host computer systems based on the validating being successful and the pre-check being successful.

2. The method of claim 1, wherein obtaining the declarative configuration includes obtaining the declarative configuration from a file on the host computer systems.

3. The method of claim 1, wherein obtaining the declarative configuration includes obtaining the declarative configuration from one of the host computer systems in the cluster of host computer systems.

4. The method of claim 1, further comprising determining eligibility of the cluster of host computer systems for the declarative configuration before navigating to the configuration screen.

5. The method of claim 1, wherein navigating to the configuration screen includes determining that configuration management is enabled for the cluster of host computer systems.

6. The method of claim 1, wherein, while in the configuration screen, pausing at a particular action and then resuming at the particular action.

7. The method of claim 1, wherein, while in the configuration screen, performing configuration canceling actions.

8. A management server for managing a cluster of host computer systems to operate according to a declarative configuration, the management server comprising:
a processor; and
a memory coupled to the processor, wherein the memory has loaded therein an application, which, when executed by the processor, causes the processor to:
navigate to a configuration screen; and
while in the configuration screen, perform actions that include:
obtaining the declarative configuration;
validating the declarative configuration;
displaying an indication of compliance by the cluster of host computer systems with the declarative configuration, wherein the cluster of host computer systems was previously configured imperatively;
performing a pre-check on the host computer systems in the cluster; and
applying the declarative configuration to the cluster based on the validating being successful and the pre-check being successful.

9. The management server of claim 8, wherein being caused to obtain the declarative configuration includes being caused to obtain the declarative configuration from a file on the host computer systems.

10. The management server of claim 8, wherein the application causing the processor to obtain the declarative configuration includes causing the processor to obtain the declarative configuration from one of the host computer systems.

11. The management server of claim 8, wherein the application further causes the processor to determine eligibility of the cluster of host computer systems for the declarative configuration before the processor navigates to the configuration screen.

12. The management server of claim 8, wherein the application causing the processor to navigate to the configuration screen includes causing the processor to determine that configuration management is enabled for the cluster of host computer systems.

13. The management server of claim 8, wherein, while in the configuration screen, the application causing a pause at a particular action and then causing a resume at the particular action.

14. The management server of claim 8, wherein, while in the configuration screen, the application causes the processor to perform canceling actions.

15. A non-transitory computer-readable medium encoding instructions, which, when executed by a processor of a management server, cause the management server to:
navigate to a configuration screen; and
while in the configuration screen performing actions that include:
obtaining a declarative configuration;
validating the declarative configuration;
displaying an indication of compliance by a cluster of host computer systems to the declarative configuration, wherein the cluster of host computer systems was previously configured imperatively;
performing a pre-check on the host computer systems in the cluster of host computer systems; and
applying the declarative configuration to the cluster of host computer systems based on the validating being successful and the pre-check being successful.

16. The non-transitory computer-readable medium of claim 15, wherein the instructions causing the management server to obtain a declarative configuration include instructions to obtain the declarative configuration from a file on the host computer systems

17. The non-transitory computer-readable medium of claim 15, wherein the instructions causing the management server to obtain the declarative configuration include instructions to cause the management server to obtain the declarative configuration from one of the host computer systems.

18. The non-transitory computer-readable medium of claim 15, wherein instructions further cause the management server to determine eligibility of the cluster for the declarative configuration before the management server navigates to the configuration screen.

19. The non-transitory computer-readable medium of claim 15, wherein the instructions causing the management server to navigate to the configuration screen includes instructions to determine that configuration management is enabled for the cluster of host computer systems:

20. The non-transitory computer-readable medium of claim 15, wherein the instructions cause the management server to, while in the configuration screen, pause at a particular action and then resume at the particular action.
